(19) United States
(12) Patent Application Publication
(10) Pub. No.: US 2010/0043742 A1
(43) Pub. Date: Feb. 25, 2010

(54) METHOD AND ELECTRODE FOR THE PRODUCTION OF A RADIAL BEARING SURFACE, AND CONNECTING ROD

(75) Inventors: Christian Martin Erdmann, Stuttgart (DE); Wolfgang Hansen, Esslingen (DE); Martin Hartweg, Erbach (DE); Karl Holdik, Ulm (DE); Thomas Kraenzler, Salem (DE); Volker Lagemann, Ulm (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/443,711

(22) PCT Filed: Oct. 17, 2007
(86) PCT No.: PCT/EP2007/008988

§ 371 Date: Mar. 31, 2009

(30) Foreign Application Priority Data
Oct. 30, 2006 (DE) 10 2006 062 687.7

(51) Int. Cl. F16C 7/00; B23H 5/06; B23H 5/10; C25F 3/02

(52) U.S. Cl. 123/197.3; 205/661; 204/280

(57) ABSTRACT

The invention relates to a method for producing a bearing surface (5) of a radial shaft bearing from electrically conductive material. In said method, the contour of the bearing surface (5) is machined down in a first machining step, and the bearing surface (5) is electrochemically machined in a subsequent step. Also disclosed are an electrode for electrochemical machining as well as a connecting rod (1) to be used in machines.

The invention relates to a method for the production of a substantially cylindrical bearing surface of a radial shaft bearing in electrically conductive material, an electrode for the electrochemical production of a bearing surface of a radial shaft bearing, as well as a connecting rod for use in machines.

When translatory movements are converted to rotary movements, connecting rods are used in machines to a great extent. The connecting rod bearings, that is, the bearing surfaces of the radial bearings, of a connecting rod shaft are thereby subjected to a very high load. The load capacity and the life cycle of the connecting rod bearings are essential for the functionality and the life cycle of a machine, in particular with internal combustion engines, here mainly with automotive engineering.

From DE 40 17 215 C2 is known an apparatus for electrochemical deburring the edges of connecting rod eyes. Thereby, the burrs resulting in the connecting rod shaft by the drilling of the so-called connecting rod eyes, that is, the connecting rod bearing surfaces are machined electrochemically. It is however furthermore disadvantageous that the connecting rod bearing surfaces themselves do not experience an increase in the load capacity and thus also an increase of the life cycle.

Based on the state of the art, it is thus the object of the invention to give an improved method for the electrochemical production of connecting rods which can bear higher loads, to give an electrode therefore, and a connecting rod which enables a higher load capacity and simultaneously a higher life cycle.

The object with regard to the method to be specified for the production of a substantially cylindrical bearing surface is solved by the characteristics of claim 1. The object with regard to the electrode to be specified is solved by the characteristics of claim 6. The object with regard to the connecting rod to be specified is solved by the characteristics of claim 8. Further advantageous arrangements and further embodiments of the invention follow from the dependent claims and the description.

The object with regard to the method to be specified is solved according to the invention in that, for the production of a radial shaft bearing in electrically conductive material, where the surface contour of the bearing surface is machined down in a first machining step, the surface contour is further machined electrochemically in a subsequent second machining step.

It is the advantage of this invention that a bearing surface is produced by means of the subsequent electrochemical machining, which is geometrically highly exact and which comprises a higher wear-resistant surface fine design. A bearing surface for a radial shaft bearing is thus created which can bear a higher load in the operating state and which has a higher wear resistance and thereby an increased life cycle as a rule compared to the state of the art.

The method according to the invention thereby comprises a conventional mechanical preferably machining down of the bearing surface to be machined in a first method step, in particular by drilling. It has to be considered thereby that the geometric machining measure for the mechanical machining has to be corrected by the amount of the machining measure of the subsequent electrochemical machining, that is, its material removal, with regard to the geometrical final contour to be produced.

In a subsequent method step, the mechanically pre-machined surface contour of the bearing surface is machined further by means of an electrochemical machining method. Sufficiently known apparatuses for the electrochemical machining are used therefore. The method of the electrochemical machining (ECM—ElectroChemical Machining) or also of the electrochemical machining developed further, the so-called pulsed electrochemical machining (PECM—Pulsed ElectroChemical Machining) is thereby characterized in that no direct contact between the tool and the machining object is present during the machining. For the machining, the tool and the machining object are positioned relatively rigid to one another and in a defined manner, so that the geometry of the machining tool is reproduced on the machining object. For this, an electrical voltage is applied between the machining tool and the object to be machined, wherein the machining object is switched as an anode, and the machining tool as a cathode. For the machining, an existing slot, preferably smaller than 1 mm, is rinsed with a conventional electrolyte solution between the tool (cathode) and the object (anode). The material removal at the machining object thus takes place electrochemically and the dissolved material is flushed from the electrolyte solution from the machining zone as metal hydroxide. The PECM method has a much lower slot width between the tool and the object, preferably a slot width of 0.01 to 0.2 mm, and therefore possesses a considerably higher machining exactness than the ECM method. It is also characteristic for the PECM method that the machining current is not applied permanently, as with the ECM method, but is supplied as a pulsed current. The method of the electrochemical machining is further distinguished by a high process stability.

Thus, the form of the tool electrode is transferred in a very exact and highly precise manner to the electrically conductive material to be machined by means of the electrochemical machining. The form of the tool electrode thereby has to be designed in dependence on the machining geometry to be produced. A conventional electrode assembly is however used as a rule, which comprises a special geometric arrangement on the geometry to be produced, for example the exact diameter of a bearing surface to be produced.

Due to the contactless machining method, the tool wear of the electrode is extremely low, whereby a high reproducibility of the method is ensured.

It is furthermore advantageous, that, with the method according to the invention, only a minimum material removal of less than 1 mm takes place during the electrochemical machining, preferably in the region of 0.005 mm to 0.1 mm. The material removal, that is, the removal rate during the electrochemical machining is further controlled directly via the voltage applied in the method and/or the conductivity of the electrolyte solution, so that the efficiency of the method according to the invention by short clock cycles can thereby be adapted with a simultaneously very high surface quality of the machined surface. That is, for a higher material thickness to be removed, a electrolyte solution with higher conductivity, that is, an increased salt part has to be chosen and/or the applied voltage has to be increased. The electrocemical machining of bearing surfaces, in particular connecting rod bearings will thereby also be economical for serial production. The machining time is reduced to a clock cycle of a few seconds depending on the material removal, preferably with a material removal of 0.1 mm to below 10 s. This clock cycle can be reduced further by the parallel machining of several components.

With regard to the highly exact machining of the method, this is increased further advantageously specially by the PECM method, whereby a high surface quality in the region of surface roughnesses R_{z} smaller than 5 μm is achieved, preferably R_{z} in the region of 0.5 μm to 2 μm. A surface is therewith produced which is considerably more even and smooth and thereby comprises a higher wear resistance compared to the conventional mechanical machining.

A further advantage of the PECM method is that a highly exact and precise machining with a structuring of the machining surface is facilitated by a corresponding arrangement of the electrode, for example a microstructuring in the form of microlubricant pockets or specifically aligned microgooves, whereby the wear resistance and the load capacity of the bearing surface is increased further.

In an advantageous arrangement, the surface contour of the bearing surface is machined in a geometrically noncircular manner in its cross section.

It is an advantage thereby that the warping of the bearing surface in the load state due to the deformation of the bearing surface is reduced by the geometrically noncircular machining in cross section of the surface contour by means of an electrochemical machining method. The load capacity and the wear resistance of the bearing surface are thereby increased further in an advantageous manner.

As such a geometrically noncircular machining geometry are thereby not to be understood rotation-symmetric geometries with regard to the geometric center of a radial bearing in cross section. For example, an elliptic, that is, a machining geometry in oval form of bearing surface is for example to be understood thereby. Such a machining cannot be produced with conventional mechanical machining at least with a justifiable effort, where this is machined in an easy manner with electrochemical machining by a corresponding arrangement of the electrode.

The advantage of the machining geometry in oval form especially with a connecting rod bearings is that the connecting rod is machined in such a manner, that it possesses a substantially rotation-symmetric circular geometry in the load state, that is, in the deformed state due to specifically acting forces. Compared to the conventional circular mechanical machining of a connecting rod eye, which is deformed in an unsymmetric manner in the load state, the machining in oval form ensures a connecting rod bearing or a bearing surface comprising a significantly higher load capacity and simultaneously an increased wear resistance. The respective arrangement of the bearing surface in oval form depends on the bearing forces occuring in the load case, but the difference of the main and secondary axis of such a machining geometry in oval form is smaller than 100 μm according to its amount, preferably in the region of 0.5 μm to 10 μm.

For the exact position of the noncircular machining geometry of the bearing surface relative to the geometric center of a radial bearing, the region or the regions of the load transmission in the load state in the bearing surface is/are critical. The smaller secondary axis of a machining geometry in oval form of a connecting rod eye with a conventional connecting rod for an internal combustion engine lies for example in the direction of the connecting rod shaft, that is, on the connecting line of the centers of the two connecting rod eyes.

A further increase of the load capacity and the wear resistance of the bearing surface is achieved if the bearing surface is machined in a spherical manner in its width. That is, a tilting of the bearing surface relative to the bearing seat of the shaft to be seated compared to a conventional coplanar arrangement of the bearing seat of the shaft and the bearing surface can be tolerated in an essentially better manner by particularly a bearing surface machined in a convex manner. With the conventional coplanar arrangement, a tilting in the edge region of the bearing surface results in a solid body contact of bearing surface and bearing seat, which results in an increased wear of the bearing surface and the bearing seat, that is, a considerably lower life cycle. With the spherical machining of the bearing surface, a tilting in such a solid body contact of bearing surface and bearing seat results only much later. The life cycle and thereby the efficiency are thus increased considerably in particular with connecting rod bearings. The measure of the spherical machining is thereby in the region of a few micrometers to 100 μm, preferably from 1 μm to 10 μm. Such a machining cannot be produced with a conventional mechanical machining at least with a justifiable effort, where this is machined in an easy manner with electrochemical machining by a corresponding arrangement of the electrode.

A further increase of the load capacity and the wear resistance of bearing surfaces for a radial shaft bearing is achieved, if the previously described solution according to the invention is combined with known coatings for bearing surfaces as for example ternary material bearings for connecting rod bearings. The bearing surface is thereby coated with an electrically conductive layer system after the mechanical machining and this is subsequently machined electrochemically corresponding to the previously described method according to the invention.

Particularly economic advantages result for the production of bearing surfaces in particular connecting rod bearings, if, due to the advantages of the electrochemical machining, expensive bearing systems as for example ternary material bearings consisting of back plate, bearing layer and running-in layer are replaced by layer systems which are simpler, more economic, and wear resistant, as for example coatings sprayed in a thermal manner or galvanic layers. The connecting rods can thereby be coated directly and further cost-intensive method steps during the production of ternary material bearings are cut down on.

Alternatively to the preliminary machining down, it is also possible with the electrochemical machining, to produce bearing surfaces directly in near-net-shaped forged or cast components, in particular the connecting rod eyes of connecting rods. This has primarily the economic advantage that numerous machining steps, as for example the machining down of the connecting rod eyes or its subsequent coating are omitted in further method steps. For ensuring the functionality of the bearing surface, in particular the high load capacity and the wear resistance, it has to be observed thereby that a correspondingly high quality forging or cast material is chosen for the component.

It is furthermore advantageous that the electrochemical machining for electrically conductive materials is a machining method not depending on material. That is, electrically conductive materials can also be machined, which can only be machined to its final contour in an inadequate manner by pure mechanical machining or only with high expenditure, for example, it is very difficult to machine down modern iron cast alloys, such as vermicular graphite cast (GGV) or bainitic cast iron with ductile graphite (ADI—Annealed Ductile Iron). These alloys have very good wear properties and high mechanical rigidity characteristic values, so that they can be used as uncoated bearing materials. By the method according to the invention, a use of these materials for example for connecting rods is enabled and a process-sure and highly exact machining of these materials with a simultaneously improved efficiency of the machining is ensured.

Further objects of the invention and further advantageous arrangements of the solutions according to the invention are explained in more detail in the following embodiment and the figures.

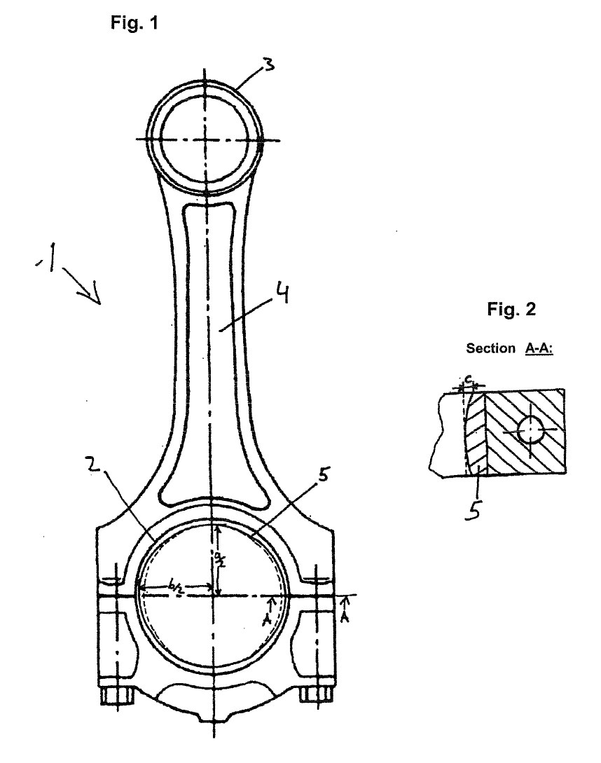

FIG. 1 thereby shows a side view, not to scale, of a connecting rod (1) according to the invention of an internal combustion engine in a schemativ view. The oval arrangement of the bearing surface (5) of the larger connecting rod bearing (2) was shown in an exaggerated manner for a better understanding.

FIG. 2 is a view of the connecting rod bearing (2) along the section A-A according to FIG. 1. The spherical arrangement of the bearing surface (5) of the larger connecting rod bearing (2) was also shown here in an exaggerated manner for a better understanding.

For the manufacture of 4 cylinder Otto engines for motor vehicles, near-net shaped cast connecting rods (1) of the material ADI are machined by means of the method according to the invention.

In a first method step, the connecting rod eyes of the connecting rod bearings (2, 3) of the cast parts are machined mechanically by drilling. The mechanically machined surfaces of the connecting rod bearings (2, 3) are subsequently coated thermally with a wear-resistant layer having a thickness of 0.5 mm by means of plasma spraying in an automated process.

In subsequent a method step, the final machining of the connecting rod bearings (2, 3) takes place by means of PECM. The electrochemical machining takes place on a conventional apparatus for the PECM machining, not described further here. The connection means for the reception of the electrodes, for the current supply, for the defined positioning of the connecting rods relative to the electrodes and for the further process control necessary for the machining are not explained in more detail here, but are naturally present.

An electrode is used for the PECM machining of the larger connecting rod bearing (3) which electrode has a height of 30 mm and an oval basic form, wherein the difference of main axis b and secondary axis a is 1 μm according to its amount and which is constant over the height of the electrode. The oval basic form is variable over the height of the electrode, so that the electrode has a concave, spherical form relative to its height. The outer edges of the spherical form are thereby cambered towards the outside by the amount c of 2 μm. A circular electrode is used for the PECM machining of the smaller connecting rod bearing (3) which electrode has a height of 30 mm and the diameter of which is variable over the height of the electrode, so that the electrode has a concave, spherical form relative to its height. The outer edges of the spherical form are thereby also cambered towards the outside by the amount c of 2 μm.

The described electrodes generate the desired spherical convex form over the width of the bearing surfaces (5) of the connecting rod bearings (2, 3), and the machining geometry in oval form at the bearing surface (5) of the larger connecting rod bearing (2) during the PECM machining at a connecting rod (1) by their special arrangement. At the same time, the electrodes deburr and and chamfer the connecting rod bearings in a defined manner.

For increasing the efficiency of the PECM machining, the electrochemical machining of four connecting rods (1) takes place in a parallel manner, whereby the apparatus has a corresponding number of previously described electrodes.

In the method for the PECM machining, the four connecting rods (1) are received and clamped in the apparatus in a defined manner, so that a rigid positioning of the connecting rods (1) relative to the electrodes is ensured. A smaller connecting rod bearing (3) respectively encloses thereby a described circular electrode, so that a circumferentially constant work slot of about 0.1 mm results. A larger connecting rod bearing (2) encloses a previously described electrode in oval form, so that the secondary axis a of the machining geometries which are machined in oval form subsequently lies in the direction of the connecting rod shaft (4), that is, on the connection line of the of the centers of the connecting rod bearings (2, 3). A minimum work slot of about 0.1 mm results from this in the area between the bearing surface (5) and the electrode, which is in the direction of the main axis b and is vertical to the secondary axis a. The electrolyte solution, a common salt solution, is introduced from above to the machining under ambient pressure. The PECM machining takes place with a clock cycle of 10 s.

During the PECM machining of the two connecting rod bearings (2, 3), the convexity of both bearing surfaces (5) already described and the geometry of the bearing surface (5) in oval form of the larger connecting rod (2) is finally produced, from which result the advantages which have already been described sufficiently.

The procedure takes place in a fully automated manner, so that the machined connecting rods (1) are removed from the apparatus after the PECM machining in an automated manner, and further connecting rods to be newly machined are introduced into the apparatus.

1. A method for the production of a substantially cylindrical bearing surface (5) of a radial shaft bearing in electrically conductive material, wherein the surface contour of the bearing surface (5) is machined down in a first machining step, and wherein the surface contour of the bearing surface (5) is further electrochemically machined in a subsequent step.

2. The method according to claim 1, wherein the bearing surface (5) is machined in a geometrically noncircular manner in its cross section.

3. The method according to claim 1, wherein the bearing surface (5) is made geometrically oval in its cross section.

4. The method according to claim 1, wherein the bearing surface (5) is machined in a spherical manner in its width.

5. The method according to claim 1, wherein the electrode used for the electrochemical machining is positioned rigidly relative to the bearing surface (5).

6. An electrode for the electrochemical machining of a substantially cylindrical bearing surface (5) of a radial shaft bearing in electrically conductive material, wherein the electrode is formed in a conical shape, and wherein the electrode comprises an oval cross section.

7. The electrode according to claim 6, wherein the electrode comprises a variable oval cross section along its longitudinal extension.

8. A connecting rod (1) suitable for use in internal combustion engines, comprising a connecting rod shaft (4) which respectively comprises a connecting rod bearing (2, 3) at its ends, wherein at least one bearing surface (5) of a connecting rod bearing (2,3) is formed in a geometrically oval manner in its cross section.

9. The connecting rod (1) according to claim 8, wherein the bearing surface (5) of the connecting rod bearing (2, 3) is formed in a spherical manner in its width.
